(19) United States
(12) Patent Application Publication
(10) Pub. No.: US 2012/0068940 A1
(43) Pub. Date: Mar. 22, 2012

(54) ELECTRONIC DEVICE

(75) Inventors: Chuan Wei Wang, Hsinchu City (TW); Cheng Nan Tsai, Hsinchu City (TW); Chun Yi Lu, Hsinchu City (TW); Horng Goung Lai, Hsinchu City (TW); Chih Hung Lu, Hsinchu City (TW)

(73) Assignee: PIXART IMAGING INC., Hsinchu City (TW)

(21) Appl. No.: 12/885,690

(22) Filed: Sep. 20, 2010

(51) Int. Cl. G06F 3/041

(52) U.S. Cl. 345/173

(57) ABSTRACT

An electronic device includes a housing, an optical touch module, and a detecting unit. The housing includes a first body and a second body, and an angle is formed between the first body and the second body. The optical touch module executes a positioning function by sensing signals. The detecting unit is configured to the optical touch module, and is used for detecting the angle. When the angle is smaller than a predetermined angle, the detecting unit instructs the optical touch module to pause executing the positioning function, so as to avoid false position determinations by the optical touch module.

### BACKGROUND OF THE INVENTION

1. Field of the Invention

The present invention relates to an electronic device, and more particularly to an electronic device having a detecting unit to detect an angle of a housing, so as to instruct an optical touch module to pause executing a positioning function.

2. Related Art

With the rapid development of technologies and the improvement of the living quality of modern people, various electronic devices, especially portable electronic devices, have gradually become indispensable in the modern life. With the advantages of light weight, thin structure and easy-to-carry, portable electronic devices such as notebook computers have been rapidly developed and gradually become a mainstream in the market with the progress in research and development technologies.

For example, a display device of a notebook computer has evolved from a conventional cathode ray tube (CRT) to a liquid crystal display (LCD). The main function of the display device is to present images to a user, and to enable the user to interact with the computer through information output by its screen. In a conventional screen operation method, the user has to use a keyboard, a mouse or other auxiliary tools in order to communicate with the computer. However, such a method increases the operational complexity, and may be rather difficult for beginners. Therefore, an optical touch monitor allowing the user to operate the computer through clicks with fingers thereon has become a relatively popular operation interface. The optical touch monitor can not only output images, but can also receive commands, so that the optical touch monitor is more intuitive than the keyboard, the mouse, or other operation interfaces, and has the advantage of clicking-while-viewing.

However, for a positioning function performed through touches on the optical touch monitor, problems still occur when the optical touch monitor is applied to the notebook computer. For example, the optical touch monitor is quite sensitive to the impact of environmental light source. In addition, since the structure of the notebook computer is mostly a compact design of thin panels for the sake of portability, when the user opens and closes the notebook computer, the optical touch monitor easily make a false position determination due to distortion and deformation of the panels during opening and closing of the notebook computer. Therefore, the problem of false position determination by the optical touch monitor not only increases the difficulty in operation for the user, but also limits the range of applications of the optical touch monitor.

### SUMMARY OF THE INVENTION

Accordingly, the present invention is an electronic device, which uses a detecting unit to sense an angle of a housing of the electronic device, so as to solve the problem of false position determinations by the optical touch monitor in the prior art.

The present invention provides an electronic device, which comprises a housing, an optical touch module, and a detecting unit. The housing comprises a first body and a second body, wherein the first body is pivoted to the second body, and an angle is formed between the first body and the second body. The optical touch module is configured to the first body, and executes a positioning function by sensing signals. The detecting unit is configured to the optical touch module, and is used for detecting the angle. When the angle is smaller than a predetermined angle, the detecting unit instructs the optical touch module to pause executing the positioning function.

In the electronic device of the present invention, when the angle is larger than the predetermined angle, and the first body is positioned for a time interval, the detecting unit instructs the optical touch module to resume executing the positioning function.

In the electronic device of the present invention, when the angle is larger than the predetermined angle, and the first body has an instantaneous swing speed, the detecting unit instructs the optical touch module to pause executing the positioning function.

Further, the present invention is an electronic device, which further uses a detecting unit to sense if the electronic device is in a standby state, so as to save system resources.

The present invention provides another electronic device, which comprises a housing, a processing module and a detecting unit. The housing comprises a first body and a second body, wherein the first body is pivoted to the second body, and an angle is formed between the first body and the second body. The processing module is used for enabling the electronic device to execute a preset function. The detecting unit is electrically connected to the processing module, and is used for detecting the angle. When the angle is smaller than a predetermined angle, the detecting unit instructs the processing module to pause executing the preset function.

In the other electronic device of the present invention, when the angle is larger than the predetermined angle, the detecting unit instructs the processing module to resume executing the preset function.

Therefore, in the electronic device of the present invention, the detecting unit can control executing or pausing the optical touch module by detecting the angle of the housing of the electronic device, so as to effectively alleviate the problem of false position determinations by the optical touch monitor in the prior art. Moreover, in the other electronic device of the present invention, the detecting unit can further determine if the electronic device is in a standby state by detecting the angle of the housing of the electronic device, so as to further save system resources.

### BRIEF DESCRIPTION OF THE DRAWINGS

The present invention will become more fully understood from the detailed description given herein below for illustration only, and thus are not limitative of the present invention, and wherein:

FIG. 1A is a schematic view of opening and closing of an electronic device according to a first embodiment of the present invention;

FIG. 1B is a schematic view of opening and closing of the electronic device according to the first embodiment of the present invention;

FIG. 2A to FIG. 2C are schematic views of a relative position of a detecting unit relative to a housing according to the first embodiment of the present invention;

FIG. 3 is a schematic view of an electronic device having an instantaneous swing speed according to the first embodiment of the present invention;

FIG. 4A is a schematic view of opening and closing of an electronic device according to a second embodiment of the present invention; and

FIG. 4B is a schematic view of opening and closing of the electronic device according to the second embodiment of the present invention.

### DETAILED DESCRIPTION OF THE INVENTION

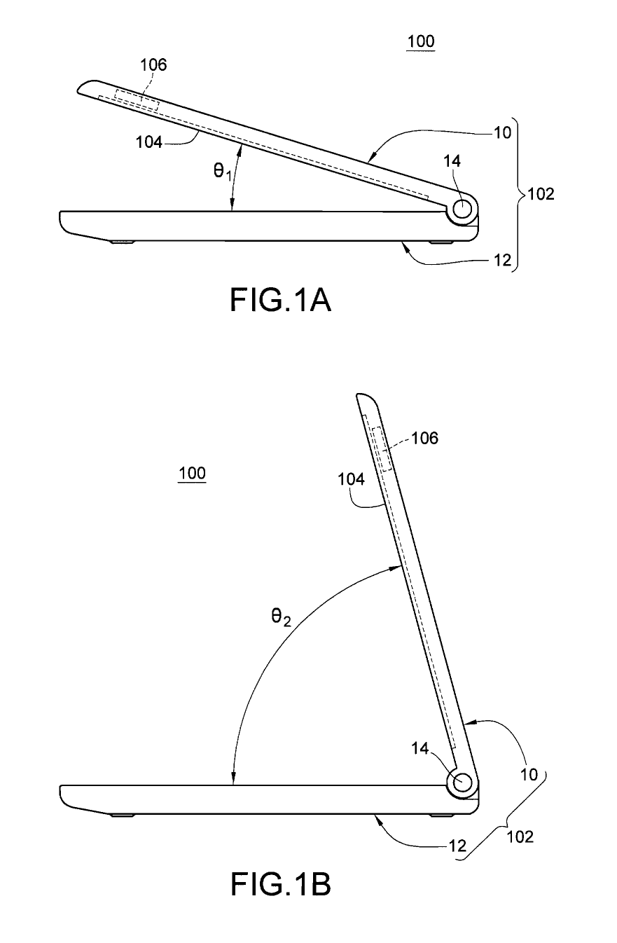

FIG. 1A and FIG. 1B show an electronic device 100 according to an embodiment of the present invention, and the electronic device 100 may be a portable navigation device, a notebook computer, or a personal mobile phone. The following description is given by taking a notebook computer as a preferred embodiment of the electronic device 100; however, the electronic device 100 is not limited thereto, and in other embodiments, the electronic device 100 may also be a portable navigation device, a personal mobile phone, or other electronic devices using a touch screen panel.

Referring to FIG. 1A and FIG. 1B, the electronic device 100 comprises a housing 102, an optical touch module 104, and a detecting unit 106. The housing 102 has a first body 10 and a second body 12, and the first body 10 and the second body 12 are respectively rotatably pivoted to a pivot 14. The pivoting positions of the first body 10 and the second body 12 are not limited to bottoms of the two, but may also be at other positions enabling relative rotation of the first body 10 and the second body 12, both of which fall within the protection scope of the present invention. In one embodiment, the first body 10 is pivoted to the second body 12, and therefore an angle θ₁ is formed there in between. While the first body 10 rotates with an axis of the pivot 14 and thus moves further away from the second body 12, the angle θ₁ increases, resulting an angle θ₂ formed between the first body 10 and the second body 12.

The optical touch module 104 is opposite to the second body 12, and is configured to a surface of the first body 10. The optical touch module 104 may be, but is not limited to, an optical touch monitor. The optical touch monitor may be an infrared screen, an optical image recognition screen, or an embedded optical touch screen. The optical touch module 104 mainly uses light-emitting diodes on X and Y axes above the screen to emit light towards edges of the screen, and uses retro-reflecting plates to reflect the light emitted by the light-emitting diodes, so as to detect a relative position of a pointer on the screen. The light emitted by the light-emitting diodes may be infrared light or visible light, and the light-emitting diodes may be infrared light-emitting diodes or visible light-emitting diodes.

That is to say, when the pointer (such as a stylus or a finger) blocks the light emitted by the light-emitting diodes in the touch area, the optical touch monitor may estimate coordinates of the pointer with an optical receiver and an internal calculation control unit, thereby achieving a positioning function. Since the cost of the light-emitting diodes is not high, the production cost will not be increased too much even if the light-emitting diodes are applied in a large-size screen. Moreover, in actual applications, a user does not need to press the optical touch monitor heavily when operating the optical touch monitor, so that the damage of the screen caused by touching can be effectively reduced.

In addition, the optical touch module 104 may also use waveguide elements to replace the conventional retro-reflecting plates. For example, the waveguide elements have a material different from outside air, such that the light emitted by the light-emitting diodes is transferred only within the waveguide elements due to different refractive indexes of the waveguide elements and the outside air. Therefore, when the light-emitting diodes are disposed at a diagonal position opposite to the optical receiver, the waveguide elements may be respectively disposed at two side edges of the touch area (such as the screen) adjacent to the light-emitting diodes. The shape of the waveguide elements may be a wedge structure with one end close to the light-emitting diodes thinner than the other end, or a flat-plate structure.

After the light transferred within the waveguide elements is scattered and distributed in the touch area, the optical receiver may be further combined with a lens, so as to increase the probability of receiving all the light in the touch area. Thus, the optical touch module 104 can effectively resist the impact of environmental light source, reduce the luminance and current consumption of the light-emitting diodes, and increase the positioning accuracy of the optical touch module 104.

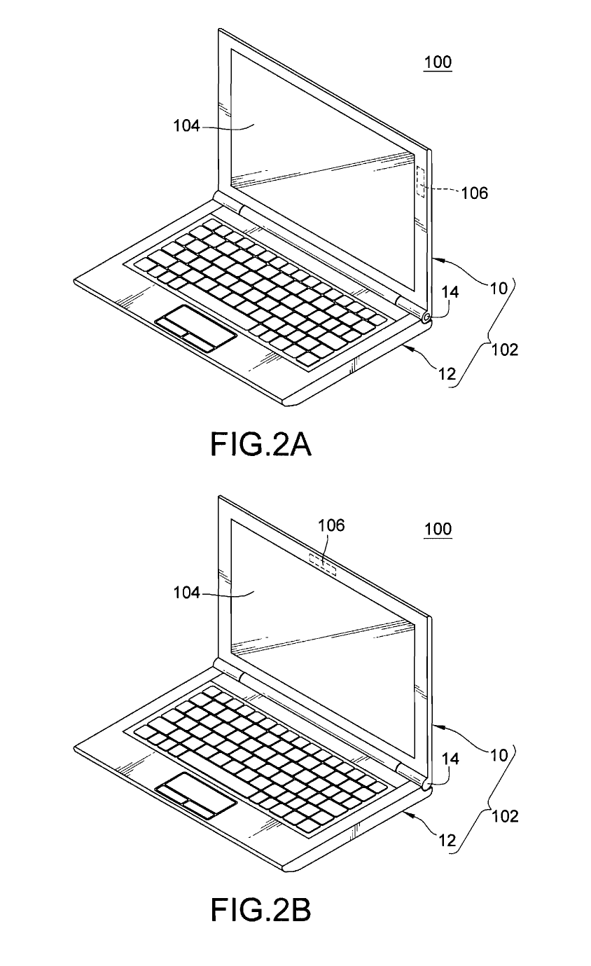

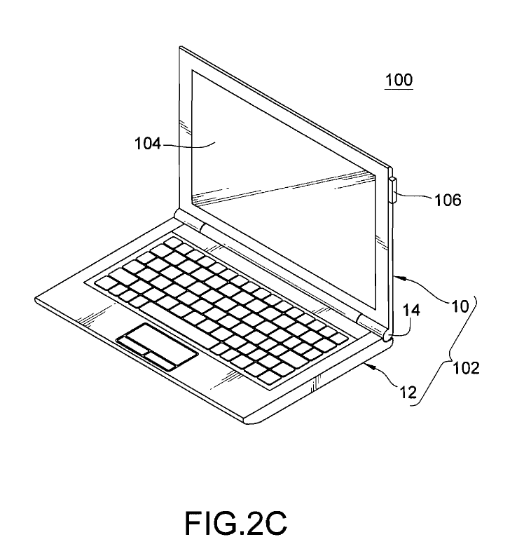

The detecting unit 106 is configured to one side of the optical touch module 104, and is used for detecting the angle of the housing 102. Specifically, when the user operates the electronic device 100, and rotates the first body 10 away from the second body 12 such that the angle changes accordingly, the detecting unit 106 may estimate the angle by sensing accelerations in a horizontal direction (X-axis direction), a vertical direction (Y-axis direction), and a longitudinal direction (Z-axis direction) relative to the electronic device 100. The position of the detecting unit 106 relative to the first body 10 may be configured as shown in FIG. 2A to FIG. 2C, that is, the detecting unit 106 is embedded at a side edge of the optical touch module 104, or configured to a periphery of the optical touch module 104. For example, in order to enable the detecting unit 106 to sense the accelerations of the three directions more effectively and obtain a value of the angle through conversion, the detecting unit 106 may be relatively disposed at a frame of the optical touch module 104, and the detecting unit 106 may be a triaxial accelerometer.

As shown in FIG. 1A, when the detecting unit 106 detects that the angle θ₁ is smaller than a predetermined angle, the optical touch module 104 pauses executing the positioning function. Here, the false position determination by the optical touch module 104 due to distortion and deformation of its screen when the electronic device 100 is just opened can be effectively avoided.

As shown in FIG. 1B, when the user opens the electronic device 100 such that the angle θ₂ is larger than the predetermined angle, the optical touch module 104 may still make a false position determination when the user touches the screen by mistake or suddenly pushes the first body 10. In order to avoid such problems under circumstances of the angle θ₂ is larger than the predetermined angle, the detecting unit 106 does not instruct the optical touch module 104 to resume executing the positioning function unless the first body 10 is positioned for a time interval.

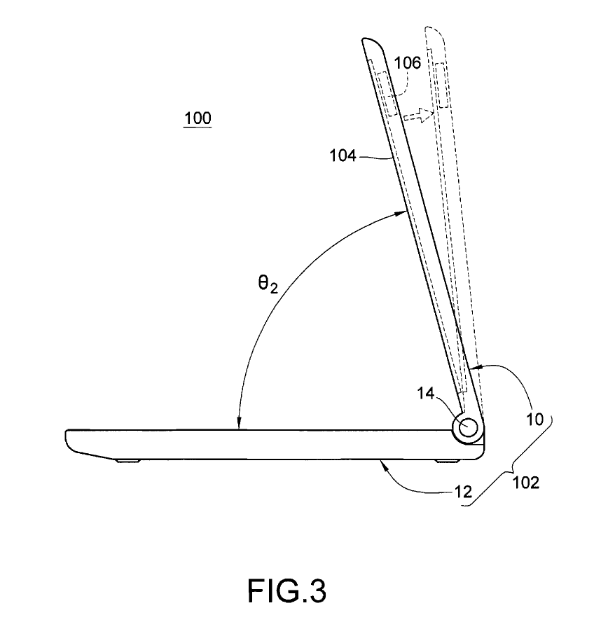

Otherwise, as shown in FIG. 3, when the angle θ₂ is larger than the predetermined angle, and the first body 10 has an instantaneous swing speed, the detecting unit 106 still instructs the optical touch module 104 to pause executing the positioning function. Here, it should be noted that, the predetermined angle and the time interval for which the first body 10 needs to be positioned are determined according to different types and operation modes of the electronic device, and are not intended to limit the scope of the present invention.

Therefore, based on the above, in the electronic device 100 according to the embodiment of the present invention, the detecting unit 106 can effectively control executing or pausing the optical touch module 104 by detecting the angle θ₁,θ₂ of the housing 102 of the electronic device 106, so as to effectively alleviate the problem of false position determinations by the optical touch monitor in the prior art.

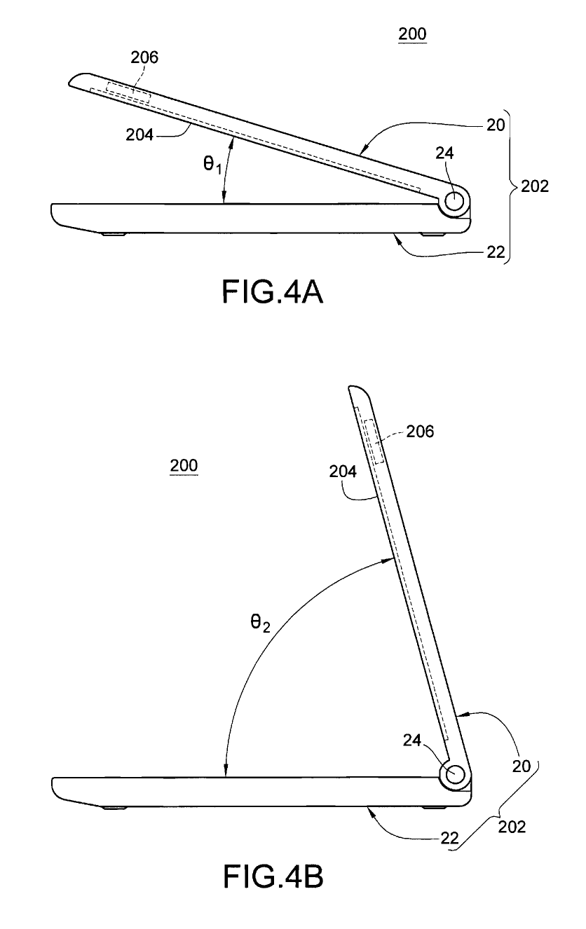

In addition, the present invention further provides an electronic device 200, as shown in FIG. 4A and FIG. 4B. The electronic device 200 comprises a housing 202, a processing module 204, and a detecting unit 206. The housing 202 has a first body 20 and a second body 22, and the first body 20 and the second body 22 are respectively rotatably pivoted to a pivot 24. The pivoting positions of the first body 20 and the second body 22 are not limited to bottoms of the two, but may also be at other positions enabling relative rotation of the first body 20 and the second body 22, both of which fall within the protection scope of the present invention. In one embodiment, the first body 20 is pivoted to the second body 22, and therefore an angle θ₁ is formed there in between. While the first body 20 rotates with an axis of the pivot 24 and thus moves further away from the second body 22, the angle θ₁ increases, resulting an angle θ₂ formed between the first body 20 and the second body 22.

The processing module 204 is configured to a surface of the first body 20, and is used for enabling the electronic device 200 to execute a preset function. For example, the processing module 204 may be an optical touch monitor, a camera device such as a web camera, an input interface device such as a keyboard device or a mouse device, or a drive device such as a hard disc drive (HDD).

The detecting unit 206 is electrically connected to the processing module 204, and is used for detecting the angle θ₁,θ₂ of the housing 202. Specifically, when the user operates the electronic device 200, and rotates the first body 20 away from the second body 22 such that the angle changes accordingly, the detecting unit 206 may estimate the angle θ₁,θ₂ by sensing accelerations in a horizontal direction (X-axis direction), a vertical direction (Y-axis direction), and a longitudinal direction (Z-axis direction) relative to the electronic device 200.

As shown in FIG. 4A, when the detecting unit 206 detects that the angle θ₁ is smaller than a predetermined angle, and accordingly determines that the electronic device 200 is in a standby mode, the processing module 204 pauses executing the preset function, so as to save operational power and system computation of the electronic device 200. As shown in FIG. 4B, when the angle θ₂ is larger than the predetermined angle, and the electronic device 200 operates in a normal processing mode, the processing module 204 resumes executing the preset function. For example, the predetermined angle may be 65 degrees. However, in actual applications, the predetermined angle should be designed according to different electronic devices 200, which is not intended to limit the scope of the present invention.

Therefore, in the electronic device 200 according to another embodiment of the present invention, the detecting unit 206 can further determine if the electronic device 200 is in a standby mode by detecting the angle θ₁,θ₂ of the housing 202, so as to further save system resources.

What is claimed is:

1. An electronic device, comprising:
a housing, comprising a first body and a second body, wherein the first body is pivoted to the second body, and an angle is formed between the first body and the second body;
an optical touch module, configured to one of the first body and the second body, wherein the optical touch module executes a positioning function by sensing signals; and
a detecting unit, configured to the optical touch module, for detecting the angle, wherein when the angle is smaller than a predetermined angle, the detecting unit instructs the optical touch module to pause executing the positioning function.

2. The electronic device according to claim 1, wherein when the angle is larger than the predetermined angle, and the first body is positioned for a time interval, the detecting unit instructs the optical touch module to resume executing the positioning function.

3. The electronic device according to claim 1, wherein when the angle is larger than the predetermined angle, and the first body has an instantaneous swing speed, the detecting unit instructs the optical touch module to pause executing the positioning function.

4. The electronic device according to claim 1, wherein the detecting unit is a triaxial accelerometer.

5. The electronic device according to claim 1, wherein the optical touch module is an optical touch monitor.

6. An electronic device, comprising:
a housing, comprising a first body and a second body, wherein the first body is pivoted to the second body, and an angle is formed between the first body and the second body;
a processing module, for enabling the electronic device to execute a preset function; and
a detecting unit, electrically connected to the processing module, for detecting the angle, wherein when the angle is smaller than a predetermined angle, the detecting unit instructs the processing module to pause executing the preset function.

7. The electronic device according to claim 6, wherein when the angle is larger than the predetermined angle, the detecting unit instructs the processing module to resume executing the preset function.

8. The electronic device according to claim 6, wherein the processing module is an optical touch monitor.

9. The electronic device according to claim 6, wherein the processing module is a camera device.

10. The electronic device according to claim 6, wherein the detecting unit is a triaxial accelerometer.

11. The electronic device according to claim 6, wherein the processing module is a drive device.

12. The electronic device according to claim 6, wherein the processing module is an input interface device.

13. The electronic device according to claim 12, wherein the input interface device is a keyboard device.

14. The electronic device according to claim 12, wherein the input interface device is a mouse device.
